(19) United States
(12) Patent Application Publication
(10) Pub. No.: US 2009/0095404 A1
(43) Pub. Date: Apr. 16, 2009

(54) Adhesive application process for roof covering materials

(76) Inventor: Robert E. Whitman, Toledo, OH (US)

Correspondence Address: Robert E. Whitman, 5110 Angola Rd, Toledo, OH, 43615, US

(21) Appl. No.: 11/973,650

(22) Filed: Oct. 10, 2007

(51) Int. Cl. B32B 37/12; C08L 21/00

(52) U.S. Cl. 156/71; 525/191

(57) ABSTRACT

A process of applying an adhesive for roofing sheets comprised of spraying in an even layered film and adhesive product comprised of the following components, such components being applied to the upper surface of roof before placement of the roofing sheet:
(a) Synthetic rubber and resin;
(b) toluene;
(c) cyclohexane;
(d) dearomatised petrol
   and after application of such adhesive produce, placing the bottom surface of rubber roofing sheets over the adhesive covered surface, moreover, the application herein covers the product comprising such stated components.

### DISCUSSION OF PRIOR ART AND BACKGROUND OF INVENTION

The concept herein relates to processes or for aiding to secure sheets of rubber roofing to the upper surface of a roof Roofing sheets comprised of rubber material are now used more widely for roof coverings because of optimal life and durability characteristics. The usual approach is to place over the upper roof surface or structure a grid-like pattern of roof sheets, dispersed over the upper roof surface and spaced relative to one another in a regular matrix-like pattern, spaced apart from one another. The rubber roof sheets are, in turn, adhered in a flush manner to the upper roof surface of such fastening plates, using a suitable adhesive.

The subject invention pertains to the application of roofing sheets and the process used to affix and adhere the roofing sheets to the surface of a roof. There needs to be a method to adhere the roofing sheets in an effective manner that withstands adverse weather and other conditions over a reasonable period of time.

Generally in this respect, roof coverings that are applied with an adhesive material that is applied to the roof surface for the roof sheet to adhere to the roof. However, the process using adhesive materials or substitutions have been marginally effective and successful. Therefore, there is need for an improved system to adhere such roofing sheets.

### OBJECTS OF THE INVENTION

In view of the above, it is an object of the subject invention to provide an improved process for affixing rubber roofing sheets to the upper surface of a roof;

Yet another object of the subject invention is to provide an improved bonding device for installing rubber roof sheets for covering roof structures'

A further object of the subject invention is to provide an improved bonding method for affixing roofing materials to a roof structure.

Still another object of the subject invention is to provide an improved adhesive product for roof coverings;

Other and further objects will become apparent from a reading of the following description taken in conjunction with the claims.

### SUMMARY OF INVENTION

The subject invention involves a process of applying an adhesive for roofing sheets comprised of spraying in an even layered film and adhesive product comprised of the following components, such components being applied to the upper surface of roof before placement of the roofing sheet:

(a) synthetic rubber and resin;

(b) toluene;

(c) cyclohexane;

(d) dearomatised petrol

and after application of such adhesive produce, placing the bottom surface of rubber roofing sheets over the adhesive covered surface, moreover, the application herein covers the product comprising such stated components.

Alternately stated, the invention herein is directed to a process used for facilitating the process of affixing shaped sheets of rubber roofing material to the upper surface of a roof. The invention relates to an improved process to adhere to adhere a roofing sheet in a flush manner to the upper rubber roof surface.

In the general embodiment of the subject invention, these rubber roof sheets are flat members having an upper surface and a lower surface and the process of adhering rubber roof sheets to the roof surface comprises in general means to coat the roof surface with an adhesive substance so that the rubber roof sheet adheres firmly. This is more fully discussed below.

More fully stated, the subject invention is a process for applying adhesive product for adhering roof covering sheets to the upper surface of a building, such process comprising applies in the following products in various combination ratios:

(a) synthetic rubber and resin;

(b) toluene;

(c) cyclohexane;

(d) dearomatised petrol;

with such product being applied by utilizing a spraying device to apply such product in an even layered film on the roof surface and then adhering the bottom surface of a roofing sheet over such applied adhesive film. This positioning of the rubber roof sheets is preferably consummated immediately after the application of the adhesive product. Additionally certain other compounds may be added to the above product to minimize the viscosity of the product and render the product more compatible with the environment.

In using this general formulation to apply rubber roof sheets or other types of roof sheets to the upper surface of a roof, the product and process above described generates a less viscous adhering substance that can for a given volume of advance can cover, in some situations approximately ten times the surface area that existing adhering products are capable of covering. This aspect therefore means that a given volumetric unit of the subject product can replace a larger quantity of the existing adhering products to accomplish the same end result if adhering roofing sheets. Additionally, the subject product as applied with the given process, as generally described has a substantially greater adhering capability and strength, with longer lasting adhering effects.

Further, in using the subject product there is no necessity to use a high pressure sprayer to apply the adhesive material by reason of a lower viscosity and no need use expensive time consuming procedures to clean the sprayer after each use. Indeed, most low pressure sprayers will be adequate to accomplish the spraying process in applying the subject adherent. Further the adhering substance herein can also be used to spray and coat the insulation material used in the roofing infrastructure in order to protect the integrity thereof. The environmentally compatible aspects are such that the composition is easy to disintegrate into a relatively harmless way into the environment.

An additional attribute of this product is that the substance herein dries more quickly without bubbling and as a result the roofing sheets can be applied more quickly so as to render the overall adhesive and installation process more efficient, with the end product having a greater adhesive quality.

### DESCRIPTION OF SPECIFIC EMBODIMENTS

The following description of one or more specific embodiments of the subject invention shall not be considered as limiting the scope of the subject invention as set forth in the claims.

In the specific embodiments of the invention herein, such embodiments of the subject invention are most applicable to roof structures where in the roof is horizontal, although it is not to be so limited. While the descriptions below are explicitly directed to an application wherein the roofing sheets comprise rubber roof sheets, it will be understood that this invention is equally applicable to those circumstances wherein rubber roof surface roof sheets are used, although the invention can be otherwise applied. Moreover, description and application of the specific embodiments are not to be considered as limiting the scope of the subject invention.

In this light, the subject invention involves as apparatus to aid in the affixing of rubber roof sheets to a roof surface such as roof which is a horizontal, flat roof having perimeter edges. Such latter roof surface is considered conventional in this regard, however, the subject invention can apply to a roof of any external configuration, whether rectangular, flat or other structural shape.

In the process of affixing rubber roof sheets to roof, the first step in the process is to lay, in a flush manner, a plurality of rectangular shaped rubber roof sheets, in a regular grid-like pattern so that all such sheets cover the entire roof surface in a flush manner. Usually, bonding plates are affixed to the upper surface of the rubber roof sheets once the rubber roof sheets are laid in the manner described above, and the such bonding plates are generally affixed in a series of evenly-spaced rows and columns, in somewhat of a grid pattern, although all these features are not critical to the subject invention.

In a general procedural arrangement of adhering the underside of roofing sheets to the roof surface an adhering process includes the use of an adhering substance being applied to the lower surface of the roof sheet or the upper surface of the roof deck in order that the roof sheets fully adhere to the roof deck in an effective and enduring manner.

In light of this above discussed aspects, the subject invention is a process for applying adhesive product for adhering roof covering sheets to the upper surface of a building, such process comprises usage of in the following products in various combination ratios:

(a) synthetic rubber and resin;

(b) toluene;

(c) cyclohexane;

(d) dearomatised petrol

with such product being applied by utilizing a spraying device to apply such product in an even layered film on the roof surface and then adhering the bottom surfaces of the roofing sheets over such applied film. This positioning of the rubber roof sheets is preferably consummated immediately after the application of the adhesive product. Additionally certain other compounds may be added to the above product to minimize the viscosity of the product and render the product more compatible with the environment.

In using this general formulation to apply rubber roof sheets or other types of roof sheets to the upper surface of a roof, the product and process above described generates a less viscous adhering substance that can for a given volume of advance can cover, in some situations approximately ten times the surface area that existing adhering products are capable of covering. This aspect therefore means that a given volumetric unit of the subject product can replace a larger quantity of the existing adhering products to accomplish the same end result if adhering roofing sheets. Additionally, the subject product as applied with the given process, as generally described has a substantially greater adhering capability and strength, with longer lasting adhering effects.

Further, in using the subject product there is no necessity to use a high pressure sprayer to apply the adhesive material by reason of a lower viscosity and no need use expensive time consuming procedures to clean the sprayer after each use. Indeed, most low pressure sprayers will be adequate to accomplish the spraying process in applying the subject adherent. Further the adhering substance herein can also be used to spray and coat the insulation material used in the roofing infrastructure in order to protect the integrity thereof. The environmentally compatible aspects are such that the composition is easy to disintegrate into a relatively harmless way into the environment.

An additional attribute of this product is that the substance herein dries more quickly without bubbling and as a result the roofing sheets can be applied more quickly so as to render the overall adhesive and installation process more efficient, with the end product having a greater adhesive quality.

In view of the foregoing, the following are some of the specific embodiment of the subject invention; to exit:

A first specific embodiment of the subject invention is a process of applying an adhesive for roofing sheets comprised of spraying in an even layered film of an adhesive product comprised generally of the following components:

(a) synthetic rubber and resin;

(b) toluene

(c) cyclohexane;

(d) dearomatised petrol,

and after application of such adhesive product, placing the bottom surface of said roof sheets over such adhesive covered surface, after application of time out this said underlying adhesive product.

Another specific embodiment of her the subject invention is a process of applying an adhesive for roofing sheets comprised of spraying in an even layered film an adhesive product compressed of the following components in the ratios indicated:

| | |
|---|---|
| (a) synthetic rubber and resin; | (37%) |
| (b) toluene | (10%) |
| (c) cyclohexane; | (29%) |
| (d) dearomatised petrol; | (24%) |

And after application of such adhesive product, placing the bottom surface of roof sheets over the adhesive covered surface, after application of such adhesive product.

Still another description of a specific embodiment of the subject invention can be described as a product to be applied an adhesive product compress of the following components:

(a) synthetic rubber and resin;

(b) toluene

(c) cyclohexane;

(d) dearomatised petrol;

A further deception of a specific embodiment of the subject invention is described as adhesive protect product for adhering roofing sheet to the upper surface of roof compressing the following components:

| | |
|---|---|
| (a) synthetic rubber and resin | 37% |
| (b) toluene | 10% |
| (c) cyclohexane | 29% |
| (d) dearomatised petrol | 24% |

Relative to the above chemical compounds used in conjunction with the adhesive spraying in the subject process, the following chemical analysis is of relevance in this aspect. The content of organic volatile compounds (VOC) in the sample was determined with Fourier Transform Infrared Spectroscopy (FT-IR), using the infrared absorption bands as assigned to characteristic functional groups and based on the presence of a number of such bands, material under consideration can be identified and with the spectra of known compounds it increases the probability of making a positive identification. In this respect, the ‘as-received’ sample of compounds used in this regard, the components separated from solvent extraction were analyzed. The infra red spectroscopy results are summarized in the following table.

| | OBSERVATIONS & |
|---|---|
| SAMPLE ANALYZED | SUGGESTED IDS |
| As-Received | Strene-isopreene block copolymer |
| | (SIS) + Solvents (most solvent |
| | bands overlapped with SIS rubber) + extra |
| | C═O Peak near 1730 cm (−1) |
| Dried at 120 degree C. | SIS block copolymer = extra C═O |
| | peak near 1730 cm |
| MEK Extracts | Aromatic hydrocarbon rresin + Pentalyn |
| | K resin (dimerized rosin |
| | ester) |

Cyclohexane, toluene and C₅-C₅ aliphatic isomers are identified as the major components in the formulation, along with indene and the derivatives thereof, as well as nonyl phenol were identified. The detection of Indene and other derivatives indicates the presence of coumarone-indene resin, an aromatic tackifier.

Moreover, a Gas Chromatography process was used for solvent quantitation. Using three levels of calibration for quantitation purposes, the summary of the analysis indicated the present of Cyclohexane and Toluene and the presence of cyclohexane and toluene were also indicated as being present. Aliphatic hydrocarbons presence was calculated by subtraction of the amount of cyclohexane and toluene from the overall quantity, which resulted in a presence in the overall admixture for application purposes. The assignments for the chemical shifts of the aromatic protons of the coumarone-indene tackifer resin are overlapped with those of the styrene aromatic protons. The other chemical shifts are consistent with the presence of proton NMR spectrum of rosin ester.

Furthermore, a Pyrolysis analysis of polymer samples at elevated temperature which degrade; polymers into monomers or small fragments and the smaller pyrolyzates could be identified by analysis. Sample components that interact less with the stationary phase spend less time in the chromatography column. In MS, the resolved sample components are ionized and separated in a mass analyzer. In order to further confirm the identity of the base polymer and to determine if SBR was present in the sample, a comparative pyrolysis GC/MS analysis of the dried sample compared with a standard of Polystyrene-isoprene block copolymer (Kraton D 1107) at 700 degree C. was performed. The peak positions and distributions of the two TICs are very similar except for the presence of indene (from coumarone-indene tackifer). The compounds as identified were positively identified as isoprene (2-methyl-1, 3 butadiene or 1, 3 pentadiene) monomer. No butadiene monomer was detected.

Under the Gel Permeation Chromatography (GPC) Analysis, a sample was analyzed by GPC for molecular weight distribution (MWD) measurement of the polymers in the sample. The higher MW peak (MW 2.2X×10(4) Dalton) was assigned to the SIS base polymer while the lower MW peak (MW 1000 Dalton) was assigned to two tackifier resins using an average of two trials.

The data from IR, NMR and pyrolysis GC/MS analysis methods are consistent with that of a base polymer composed of a polystyrene-isoprene (SIS) block copolymer or SIS rubber. No styrenebutadiene copolymer (SBR) was detected. However, isoprene has on CH3 group on a double bonded carbon. The performance of SIS block polymer and SBS block polymer based adhesives should be similar because of their similar structure. However, SIS is more compatible with natural rubber and SBS polymer is more compatible with styrene butadiene rubber (SBR). The trace anti-oxidant, BHT, was detected, which was used to protect against oxygen attack of the polymers. However, no UV stabilizer was positively identified.

In the preferred embodiment, the subject invention comprises the process of applying the following product, or any variant thereof including other compounds hydrogen or nitrogen based compounds, or other additive.

(a) synthetic rubber and resin

(b) toluene

(c) cyclohexane

(d) dearomatised petrol

Such application herein consummated by a sprayer applying a film of such product over a roof surface and then placing the bottom surface of one or more rubber roof sheets over the upper surface of such film of adhesive material.

1. A process of applying an adhesive for roofing sheets comprised of spraying in an even layered film an adhesive product compressed of the following components:
(a) synthetic rubber and resin;
(b) toluene
(c) cyclohexane;
(d) dearomatised petrol;
after application of such adhesive product, placing the bottom surface of rubber roof sheets over the adhesive covered surface, after application of such adhesive product.

2. An adherent for roofing sheets comprised of:

| | |
|---|---|
| (a) synthetic rubber and resin | 37% |
| (b) toluene | 10% |
| (c) cyclohexane | 29% |
| (d) dearomatised petrol | 24% |
